(19) United States
(12) Patent Application Publication
(10) Pub. No.: US 2018/0367480 A1
(43) Pub. Date: Dec. 20, 2018

(54) OPTIMIZING CHAT-BASED COMMUNICATIONS

(71) Applicant: RapportBoost.ai, Inc., Marina del Rey, CA (US)

(72) Inventor: MICHAEL HOUSMAN, San Francisco, CA (US)

(73) Assignee: RapportBoost.ai, Inc., Marina del Rey, CA (US)

(21) Appl. No.: 16/011,438

(22) Filed: Jun. 18, 2018

Related U.S. Application Data
(60) Provisional application No. 62/521,475, filed on Jun. 18, 2017.

(51) Int. Cl. H04L 12/58; G06N 5/02; G06N 99/00

(52) U.S. Cl. CPC H04L 51/04; G06N 99/005; G06N 5/02

(57) ABSTRACT

An apparatus, system, and method are disclosed for optimizing chat-based communications. A message module receives an outgoing message comprising a portion of a conversation between an agent and a user. An outgoing message may be generated in response to an incoming message from the user and received prior to sending the outgoing message to the user. An analysis module analyzes an incoming message and an outgoing message using a predefined machine learning model to identify one or more features of the outgoing message that have an influence on a desired outcome based on the incoming message. An action module generates one or more corrective actions related to the outgoing message based on one or more features that are identified using the machine learning model. One or more corrective actions are intended to increase the likelihood that an outgoing message will result in a desired outcome.

### CROSS-REFERENCES TO RELATED APPLICATIONS

This application claims the benefit of U.S. Provisional Patent Application No. 62/521,475 entitled “System and Method for Auto-Correction of Outgoing Messages Within a Chat-Based Communication” and filed on Jun. 18, 2017, for Michael Housman, which is incorporated herein by reference.

### FIELD

This invention relates to chat-based communications and more particularly relates to optimizing responses to received messages using machine learning.

### BACKGROUND

Chat and mobile messaging is becoming an increasingly popular way for merchants to interact with their customers. Human online agents and chat-bots becoming more prevalent with companies looking to provide a better customer service experience. When a user chats with an online agent or a chat bot, the interaction experience the user has shapes the user's likelihood of purchasing goods or services, of having a pleasant customer experience, of engaging in some behavior desired by the company, or the like. Because chat-based communications are based in textual messages, with no facial expressions or vocal inflections, it is important to select the right words or phrases to ensure a positive outcome for the customer and the merchant.

### SUMMARY

An apparatus for optimizing chat-based communications is disclosed. A system and method also perform the functions of the apparatus. An apparatus includes, in one embodiment, a message module that receives an outgoing message comprising a portion of a conversation between an agent and a user. An outgoing message may be generated in response to an incoming message from the user and received prior to sending the outgoing message to the user. An apparatus, in further embodiments, includes an analysis module that analyzes an incoming message and an outgoing message using a predefined machine learning model to identify one or more features of the outgoing message that have an influence on a desired outcome based on the incoming message. In various embodiments, an apparatus includes an action module that generates one or more corrective actions related to the outgoing message based on one or more features that are identified using the machine learning model. One or more corrective actions are intended to increase the likelihood that an outgoing message will result in a desired outcome.

An apparatus includes, in one embodiment, means for receiving an outgoing message comprising a portion of a conversation between an agent and a user. An outgoing message may be generated in response to an incoming message from the user and received prior to sending the outgoing message to the user. An apparatus, in further embodiments, includes means for analyzing an incoming message and an outgoing message using a predefined machine learning model to identify one or more features of the outgoing message that have an influence on a desired outcome based on the incoming message. In various embodiments, an apparatus includes means for generating one or more corrective actions related to the outgoing message based on one or more features that are identified using the machine learning model. One or more corrective actions are intended to increase the likelihood that an outgoing message will result in a desired outcome.

A method includes, in one embodiment, receiving an outgoing message comprising a portion of a conversation between an agent and a user. An outgoing message may be generated in response to an incoming message from the user and received prior to sending the outgoing message to the user. A method, in further embodiments, includes analyzing an incoming message and an outgoing message using a predefined machine learning model to identify one or more features of the outgoing message that have an influence on a desired outcome based on the incoming message. In various embodiments, a method includes generating one or more corrective actions related to the outgoing message based on one or more features that are identified using the machine learning model. One or more corrective actions are intended to increase the likelihood that an outgoing message will result in a desired outcome.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for optimizing chat-based communications;

FIG. 2 is a schematic block diagram illustrating one embodiment of an apparatus for optimizing chat-based communications;

FIG. 3 is a schematic block diagram illustrating one embodiment of another apparatus for optimizing chat-based communications;

FIG. 4 is a schematic flow-chart diagram illustrating one embodiment of a method for optimizing chat-based communications; and

FIG. 5 is a schematic flow-chart diagram illustrating one embodiment of another method for optimizing chat-based communications.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

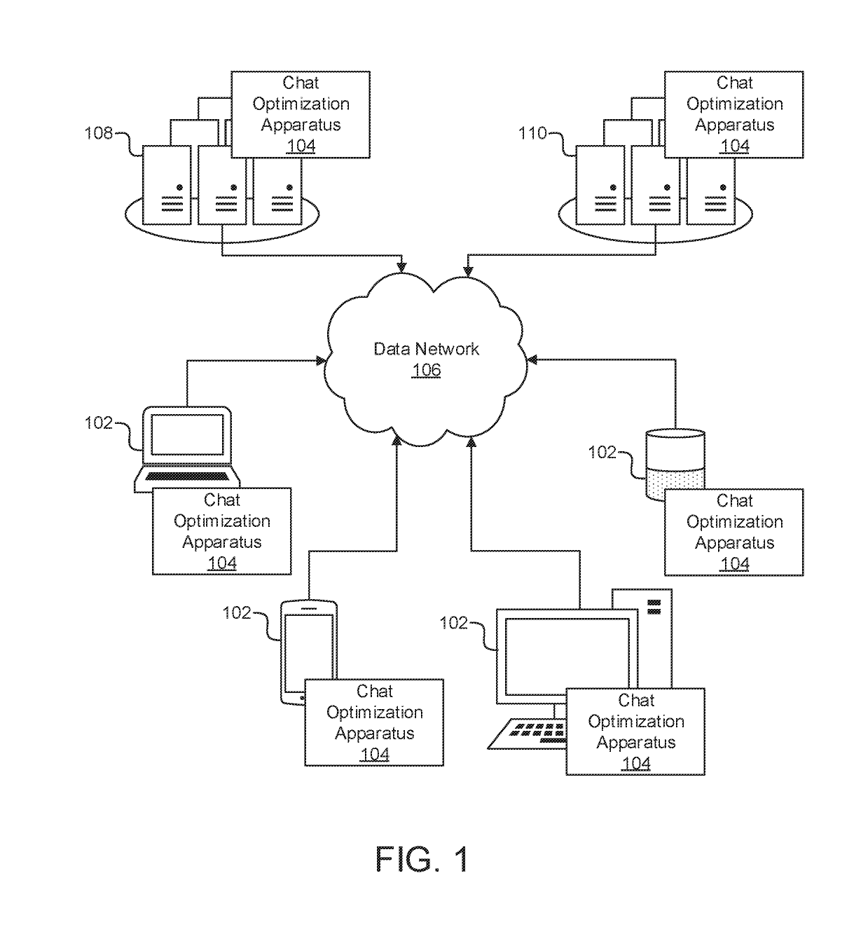

FIG. 1 depicts one embodiment of a system for optimizing chat-based communications. In one embodiment, the system 100 includes one or more information handling devices 102, one or more chat optimization apparatuses 104, one or more data networks 106, one or more agent servers 108, and one or more analysis servers 110. In certain embodiments, even though a specific number of information handling devices 102, chat optimization apparatuses 104, data networks 106, agent servers 108, and analysis servers 110 are depicted in FIG. 1, one of skill in the art will recognize, in light of this disclosure, that any number of information handling devices 102, chat optimization apparatuses 104, data networks 106, agent servers 108, and analysis servers 110 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like for receiving, sending, transmitting, displaying, processing, and/or the like chat-based communications. As used herein, chat-based communications may refer to any kind of communication over a network that offers a real-time transmission of text or audio messages between a sender and a receiver. The sender and/or receiver may comprise a real person or a chat-bot, which is a computer program or an artificial intelligence that conducts a conversation using text or audio messages in lieu of, or in addition to, a real person.

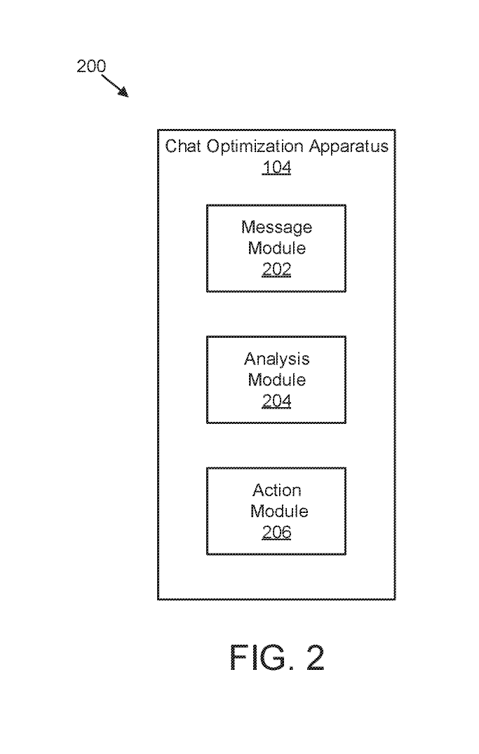

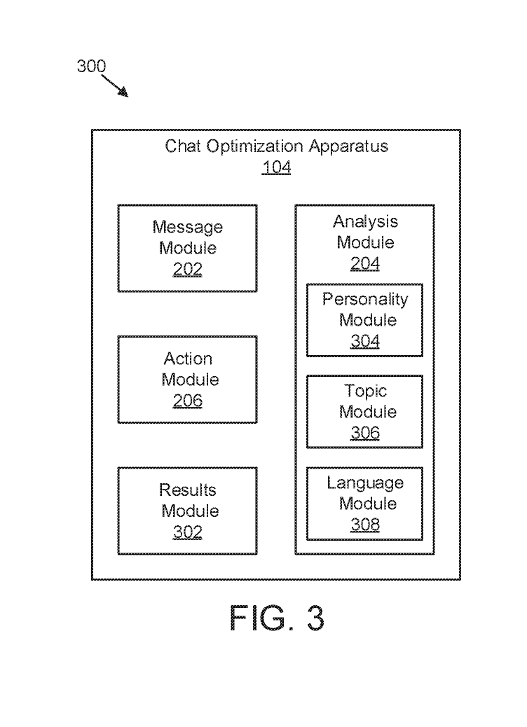

In one embodiment, the chat optimization apparatus 104 is configured to receive an outgoing message that is intended for a recipient user, and which is part of an ongoing conversation with the user; analyze the outgoing message and an incoming message that was received prior to the outgoing message being sent using a machine learning model in order to identify various features of the outgoing message that may affect a desired outcome associated with the interaction with the user; and generate corrective actions for the outgoing message based on the identified features to increase the likelihood that the outgoing message will result in the desired outcome. The chat optimization apparatus 104, including its various sub-modules, may be located on one or more information handling devices 102 in the system 100, one or more servers 108, one or more network devices, and/or the like. The chat optimization apparatus 104 is described in more detail below with reference to FIGS. 2 and 3.

In one embodiment, the chat optimization apparatus 104 improves upon conventional methods of online, chat-based communications by analyzing a conversation and/or a message of the conversation using machine learning algorithms to determine an optimal way to respond, either for a chat-bot or a human, in order to achieve a desired objective or outcome, e.g., to engage a user, to close a sale, to commit the user to do something, to provide customer service, or the like. Furthermore, the chat optimization apparatus 104 provides a number of corrective actions to implement the optimal response such as auto-correcting a response, providing response recommendations, selecting a predefined response, and/or the like. Conventional chat systems cannot provide responses and carry on a conversation that is persuasive and engaging because conventional chat systems do not employ message analysis and machine learning as described herein.

In various embodiments, the chat optimization apparatus 104 may be embodied as a hardware appliance that can be installed or deployed on an information handling device 102, on an agent server 108, or elsewhere on the data network 106. In certain embodiments, the chat optimization apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the chat optimization apparatus 104 may include a power interface, a wired and/or wireless network interface, a graphical interface that attaches to a display, and/or a semiconductor integrated circuit device as described below, configured to perform the functions described herein with regard to the chat optimization apparatus 104.

The chat optimization apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the chat optimization apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the chat optimization apparatus 104.

The semiconductor integrated circuit device or other hardware appliance of the chat optimization apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the chat optimization apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more agent servers 108, in one embodiment, may be embodied as blade servers, mainframe servers, tower servers, rack servers, and/or the like. The one or more agent servers 108 may be configured as mail servers, web servers, application servers, FTP servers, media servers, data servers, web servers, file servers, virtual servers, and/or the like. The one or more agent servers 108 may be communicatively coupled (e.g., networked) over a data network 106 to one or more information handling devices 102.

The analysis servers 110, in one embodiment, comprise servers as described above; however, the analysis servers 110 are configured to receive a message or conversation, analyze the message/conversation using machine learning algorithms, and provide corrective actions back to the agent servers 108 prior to the outgoing message being sent to a user on a client information handling device 102. Thus, the analysis servers 110 store, process, analyze, and/or the like data and algorithms for training machine learning models, for processing new data to predict results (e.g., message responses) using the machine learning models, for configuring and executing deep neural networks, and for providing response recommendations, auto-correcting the outgoing message, selecting a different outgoing message, and/or the like. The machine learning data and algorithms, or a portion thereof, may also be located on the agent servers 108.

FIG. 2 depicts an embodiment of an apparatus 200 for optimizing chat-based communications. In one embodiment, the apparatus 200 includes an embodiment of a chat optimization apparatus 104. In certain embodiments, the chat optimization apparatus 104 includes one or more of a message module 202, an analysis module 204, and an action module 206, which are described in more detail below.

The message module 202, in one embodiment, is configured to receive an outgoing message that is intended for a recipient user. For instance, the outgoing message may be a message that is generated, created, or the like and sent from the agent servers 108 to a user on a client information handling device 102. In certain embodiments, the outgoing message is a portion of an ongoing conversation between an agent and the user. As used herein, a user may be a recipient of a message, a user that initiated the chat conversation, a visitor of a website, a customer, and/or the like. An agent, as used herein, may comprise a chat bot or person for a web site/organization/company/store that the user is chatting with. In such an embodiment, the outgoing message may be generated or created in response to receiving an incoming message from a user. For example, the outgoing message may be manually drafted by a live-person agent who is communicating with the user or the outgoing message may be automatically drafted by a chat-bot in response to the user sending an incoming message, such as a product query, a customer service query, and/or the like. The message module 202 may send the outgoing message to an analysis server 110 prior to the outgoing message being sent to the user.

In one embodiment, the incoming message may comprise a textual message that a user types, that is transcribed from a voice command, e.g., a speech-to-text transcription, and/or the like. The incoming message may be received from a chat application such as an instant message program, a chat service for an online retailer, a social media chat program, and/or the like. In response to the incoming message being received, the message module 202 may trigger the generation of an outgoing response message. As described herein, in order to effectively engage the user and move the conversation forward towards an ultimate outcome such as completing a sale, providing effective customer service, generating a lead, and/or the like, the chat optimization apparatus 104 receives the outgoing message prior to the message being sent to the user who initiated the conversation, and analyzes the message using machine learning algorithms to determine whether the response is effective, and if not, adjusting message or providing alternate responses for the user.

The analysis module 204, in one embodiment, analyzes the incoming message and the outgoing message using a predefined machine learning model to identify one or more features of the outgoing message that have an influence on a desired outcome based on the incoming message. The analysis module 204, for instance, may process the incoming message to determine different features of the message such as a topic of the message, a personality of the user that sent the message based on the language in the message, and analyzing the language in the message itself for different textual predictors that identify the topic, the user's personality, phase of the conversation, or the like.

The analysis module 204, in one embodiment, trains the machine learning model, or a plurality of different machine learning models, based on previous conversations between users and agents, e.g., between customers and company representatives. As used herein, machine learning refers to a subset of artificial intelligence that often uses statistical techniques to give computers the ability to “learn” (i.e., progressively improve performance on a specific task) with data, without being explicitly programmed. Machine learning techniques may be used to devise complex models and algorithms, including neural networks, linear regression, logistic regression, polynomial regression, stepwise regression, ridge regression, lasso regression, ElasticNet regression, and/or the like, which lend themselves to prediction. Thus, as it relates to the subject matter described herein, the machine learning models may be used to predict an optimal response to an incoming message based on a previous message, based on a series of messages, based on an entire conversation, based on previous conversations, and/or the like; may be used to predict the user's personality, a topic of the message and/or conversation, a phase of the conversation, textual predictors within the message/conversation, and/or the like.

Thus, the analysis module 204 may generate, define, create, devise, or the like one or more machine learning models based on previous messages, conversations, and/or the like and then use the models to analyze the current message/conversation in order to predict, forecast, or the like potential and optimal ways to respond to the user during the conversation, e.g., in real-time. The previous conversations may be between the same agent and user/customer, between the same agent and different users/customers, between different agents and the same user/customer, and/or between different agents and different users/customers.

The analysis module 204 may identify, in one embodiment, a target or desired outcome of the message, the conversation, and/or a combination of message- and conversation-level outcomes. For instance, as discussed above, a message-level target/outcome may comprise providing a response or message that is intended to further engage the user during the conversations, to elicit a response from the user, or the like. This may include asking questions, clarifying the user's incoming message, providing a response answers the user's questions, linking to external sources, and/or the like. A conversation-level target/outcome may include a desired outcome of the entire interaction with the user/customer such as performing an action, completing a sale, generating a lead, signing the customer up, gathering customer information, receiving a customer review, and/or the like. Messages and conversations, in certain embodiments, may include multiple different targets/outcomes (e.g., a conversation outcome to provide answers to a customer's queries about a product and to persuade the customer to purchase the product).

The analysis module 204 may determine the desired outcome based on input from the user that initiated the conversation, input from the agent, analyzing the text of the incoming and/or outgoing messages, and/or the like. For instance, when the customer initiates the chat, there may be an option to specify what the issue, problem, question, or the like the customer has. Alternatively, the analysis module 204 may dynamically determine the desired outcome based on the text of the incoming messages, based on the interactions between the user and the agent, and/or the like.

Once the machine learning models are trained, in one embodiment, the analysis module 204 can use the machine learning models to evaluate an incoming and/or an outgoing message to identify different features of the messages that may have an influence on a target or desired outcome of the message and/or the conversation. For instance, as described above, the features that may have an influence on the desired outcome may be associated with the user's personality, a topic of the message/conversation, textual predictors of the outgoing message, and/or the like, and the analysis module 204 may train machine learning models to identify, predict, and/or the like the various features of the message/conversation.

In one embodiment, the analysis module 204 assigns, determines calculates, or the like a score, rank, rating, or the like to the outgoing message based on the likelihood of the outgoing message resulting in the desired outcome. The analysis module 204 may determine the score based on the analysis of the outgoing message using the machine learning model. The machine learning model, for instance, may analyze the outgoing message as a function of the desired outcome and previous messages/conversations that are substantially similar to the current message/conversation, and which the machine learning model has been trained on, to determine a score for the outgoing message.

The machine learning model, for instance, may include various weights or scores for different features of a message based on the context of the message (e.g., the phase of the conversation, the topic of the conversation, the personality of the user, or the like) and the desired outcome, and the analysis module 204 may determine a score for the outgoing message by analyzing the features of the outgoing message as a function of the corresponding weighted features of the machine learning model to calculate the score for the message (e.g., by assigning weights to each function and averaging the total sum of the weights, or the like).

In one embodiment, the action module 206 is configured to generate one or more corrective actions related to the outgoing message based on the one or more features identified using the machine learning model. In various embodiments, the one or more corrective actions are intended to increase the likelihood that the outgoing message will result in the desired outcome. The corrective action, for instance, may be based on the predictions, forecasts, recommendations, and/or the like determined by analyzing the incoming and/or outgoing message using the machine learning model.

In one embodiment, the one or more corrective actions comprises selecting a response from a library of predefined responses. For instance, the action module 206 may maintain a library, repository, data store, corpus, and/or the like of predefined, previously used, or the like responses that can be used instead of, or in place of, the outgoing message. For instance, the score for the outgoing message may be compared to the scores of the predefined messages that are related to the desired outcome, and the message with the highest score, indicating a higher likelihood of resulting in the desired outcome, may be selected as the outgoing message.

In one embodiment, the library of predefined responses is organized by message topic. In such an embodiment, once an agent's outgoing message is assigned to a message topic, messages from the same group of topics may be selected based on their similarity to the original message and/or their likelihood of yielding a positive message-level or conversation-level outcome, which has been determined beforehand. If any of the predefined messages are more likely to attain the target/outcome than the agent's current outgoing message, and the analysis module 204 determines that the two messages are functionally similar in meaning, the action module 206 message is transmitted to the agent as a more optimal response.

In further embodiments, the one or more corrective actions comprises analyzing a plurality of potential messages, including the outgoing message, using a decision tree, and selecting the message that has the highest likelihood of resulting in the desired outcome. The decision tree, for instance, may be used as a predictive model to go from observations about an item (represented in the branches) to conclusions about the item's target value (represented in the leaves). For instance, the features of the outgoing message and the potential responses (e.g., from the response library) may be the branches of the tree, and the leaves may be the likelihood, probability, or other values that indicate the chance of the message resulting in the desired outcome. The message with the highest likelihood may be selected as the outgoing message.

For example, a pre-scripted chat-bot may transmit several potential messages as part of decision tree; the multiple potential messages may be passed via an API to the system for analysis. Having followed the entire conversation from the initial message (by receiving and analyzing all incoming and outgoing messages), the chat optimization apparatus 104 determines which message is likely to have the best outcome, and then the best messages (e.g., the message that are most likely to attain the target) are passed to the agent.

In one embodiment, the one or more corrective actions comprises modifying the language of the outgoing message in real-time in response to analyzing the outgoing message using the machine learning model with language variations within the message until a message that has the highest likelihood of resulting in the desired outcome is determined. The analysis module 204, for instance, may calculate the likelihood scores of various responses that the action module 206 generates by substituting different language terms, phrases, words, n-grams, or grammar elements, based on the predictions generated by the machine learning model, into the outgoing response to generate a response that has a high, or the highest, likelihood score.

For example, if an agent uses a word in an outgoing message that is less likely to achieve a positive outcome than a synonym of that word, the action module 206 either automatically substitutes the synonym or it highlights or underlines the words and presents a better alternative when the agent hovers his cursor over that word. In such an embodiment, the analysis module 204 analyzes the language of the agent's outgoing message and determines, using machine learning, which factor or factors (e.g. emotionality, formal vs. informal, emoticons, spelling, grammar, punctuation, appreciation words, persuasive words, and/or the like) are driving the predicted outcome most heavily. Then, the action module 206 may make one or more changes to that particular language element or elements. For instance, the action module 206 may remove or add an emoticon, change the language to read more formal or informal, and so on. In one embodiment, the action module 206 presents suggestions in-line with the text that the agent has typed, highlighted or otherwise made to stand-out, with an alternative option presented when the agent clicks-on or hovers over that specific word.

In one embodiment, the one or more corrective actions comprises presenting one or more recommendations for increasing the likelihood of the outgoing message resulting in the desired outcome in real-time while the agent creates the outgoing message. The recommendations may include recommendations for a particular response, for modifying or suggesting different response language, words, n-grams, text, phrases, grammar, and/or the like, which are determined as a result of analyzing the previous incoming and outgoing messages using the machine learning model.

For example, the following questions are three possible remarks that may be used in the same conversational topic but that may produce different outcomes:
a. Are you interested in making a donation to the United Way?
b. Are you interested in fighting hunger by making a contribution to the United Way?
c. You seem like a very empathic person; would you be interested in helping to fight world hunger?

Each of the questions has a similar desired outcome (e.g., eliciting a donation from a user) but is phrased very differently and is likely to produce a very different outcome depending on who the target user is. The action module 206 may “auto-correct” the outgoing message by automatically changing the agent's message prior to the message being sent to the customer. In one embodiment, the action module 206 may present the recommendations in line with the text in real-time as the agent is typing, or present the entire auto-corrected message before it is sent to the customer. In such an embodiment, the agent is given the chance to approve or discard the recommended message.

The action module 206, in various embodiments, tracks the number of messages that are accepted versus rejected, and the types of changes that receive an acceptance versus a rejection. The analysis module 204 may use this information to further train the machine learning models, e.g., to fine-tune future auto-correction behavior. In one embodiment, the action module 206 presents an explanation describing the reasons for the correction in the message and/or for the recommended messages, as well as the change to the outcome score as a result. In certain embodiments, the explanations can help the agent overcome their reluctance to use the auto-correct feature.

In one embodiment, the action module 206 uses memory-optimized storage appliances that are configured to efficiently cache words, phrases, recommendations, and/or the like. In one embodiment, the action module 206 splits the storage into shards that are indexed by customer and message characteristics to facilitate quick calculations, efficient routing, and data retrieval. The storage may be configured to scale linearly by adding new search index nodes and performing automatic shard rebalancing. In certain embodiments, near real-time indexing may be achieved by buffering and batch processing recent chat KPI, visitor, and incoming/outgoing messages.

In various embodiments, the action module 206 performs the one or more corrective actions automatically, e.g., in situations where the agent is a chat bot. In embodiments where the agent is a human, the action module 206 may present the corrective actions to the agent for the agent to review, select, and/or otherwise manually confirm or approve of the corrective actions. Regardless, after the action module 206 performs the various corrective actions on the message, the message module 202 may then send the outgoing message to the user.

FIG. 3 depicts an embodiment of an apparatus 300 for optimizing chat-based communications. In one embodiment, the apparatus 300 includes an embodiment of a chat optimization apparatus 104. In certain embodiments, the chat optimization apparatus 104 includes one or more of a message module 202, an analysis module 204, and an action module 206, which may be substantially similar to the message module 202, the analysis module 204, and the action module 206 described above with reference to FIG. 2. Furthermore, the chat optimization apparatus 104 may include one or more of a results module 302, a personality module 304, a topic module 306, and a language module 308, which are described in more detail below.

The results module 302, in one embodiment, is configured to determine whether the desired outcome has been achieved. For message-level outcomes, the results module 302 may determine whether the user/customer responded to the outgoing message, and may analyze how the user responded to the outgoing message, e.g., length of the message, whether the message comprises an answer to a question from the agent, and/or the like. For conversation-level outcomes, the results module 302 may determine whether a final outcome was determined such as whether a product was purchased, whether the user provided contact information, whether the user registered for an account, and/or the like. In such an embodiment, the results module 302 may analyze external data sources related to the conversation to determine whether the desired outcome was achieved. For example, the results module 302 may look at purchase orders, sales transactions, customer service orders, account registries, lead databases, and/or the like.

The personality module 304, in one embodiment, is configured to analyze, using the machine learning model, one or more conversational variables of the conversation to determine the personality of the user, e.g., based on the incoming messages from the user. As used herein, the personality may include an emotion, a feeling, a personality type, and/or the like. The one or more conversational variables of the user may include a timing in the user's responses, the user's use of pronouns, the user's spelling and grammar usage, the user's choice of words, the user's use of emoticons, and the user's writing style. The personality module 304 may analyze the various conversational variables and analyze them using the machine learning model to predict or forecast a personality for the user such as happy, angry, impatient, annoyed, irritated, confused, satisfied, and/or the like. Accordingly, the action module 206 may use the determined personality to determine one or more corrective actions for the outgoing message.

Furthermore, in one embodiment, the personality module 304 analyzes, using the machine learning model, one or more conversational variables to determine the personality of the agent based on the outgoing messages from the agent. In such an embodiment, for example, the personality module 304 may determine the current personality of the agent (e.g., how the agent is “coming across” to the user), and the action module 206 may recommend different responses or tips to the agent based on the current personality of the user such as “be more outgoing”, “be more friendly”, “use more direct language”, “use terms such as . . . ”, and/or the like.

In one embodiment, the personality module 304 creates “collections” that comprise a group of different types of words that fall under a certain personality. For instance, if the personality type is friendliness, the collection may comprise various dissent words, sympathy words, appreciation words, and/or the like, which the action module 206 may display to the agent so that the agent can select potentially useful words to include in the message.

In some embodiments, the personality module 304 further segments the user based on the conversational variables and demographic variables associated with the user using one or more dimensionality reduction techniques. For instance, the personality module 304 groups or segments the personality type of the user/customer based on: (1) demographic variables (e.g., browser, location, age, sex location—if known); and/or (2) conversational variables (e.g., visit spelling, formality, use of emoticons, frustrated words, etc.). These variables can be captured directly from the visitor or their side of the conversation and then any number of dimensionality reduction techniques—for example, principal component analysis (“PCA”) or K-means clustering—can be applied in order to group visitors within a certain number of segments or clusters. The determined segments may be used as input to the machine learning model to predict personalized responses to the incoming message that increase the likelihood that the outgoing message will result in the desired outcome.

In one embodiment, the topic module 306 is configured to perform topic modeling on at least one of the incoming and outgoing message to determine a subject matter of the message. The message topic may be a rough estimation of the subject matter of the message. For example, messages including the words “restaurant” or “eat” may be classified into the “food” topic. In order to account for different message and conversational topics that may occur with a chat and to include measures in our model for the context around words and phrases, topic modeling is performed at the level of a single message or an entire conversation (typically splitting up incoming and outgoing messages).

For instance, the topic module 306 may analyze the incoming and outgoing messages for features, keywords, and/or the like, using the machine learning model and other machine learning algorithms such as K-means clustering, Latent Dirichlet Allocation, and/or the like to predict the topic of the message based on historical messages. As used herein, K-means clustering aims to partition n observations into k clusters in which each observation belongs to the cluster with the nearest mean, serving as a prototype of the cluster.

K-means clustering may be performed by processing all words within a sample of text (aside from stop-words) to a Word2Vec algorithm, or the like, in order to convert the words into vectors. Those vectors may then be averaged to generate “text vectors”, and then, if necessary, principal component analysis is performed for dimensionality reduction before K-means analysis is executed to cluster the texts. The determined topic(s) may be further used as input into the machine learning model to predict the optimal response to an incoming message and to take one or more corrective actions on the outgoing message.

The K variable in the K-means analysis is pre-specified in order to generate a certain number of clusters (e.g., 50, 100, 250, 500, or 1000) and every sample with text is assigned to one of the K-means clusters. During a subsequent analysis, cluster identifiers are further coded in order to determine which clusters are most/least strongly predictive of outcomes.

Furthermore, as used herein, Latent Dirichlet Allocation is a generative statistical model that allows sets of observations to be explained by unobserved groups that explain why some parts of the data are similar. For example, if observations are words collected into documents, it posits that each document is a mixture of a small number of topics and that each word's creation is attributable to one of the document's topics. Latent Dirichlet Allocation is performed on the client corpus in order to generate a certain number of topics (typically 10, 25, and 50) and determine what proportion of each text sample can be assigned to each topic (unlike the K-means clustering, topics are not mutually exclusive, and conversations can span multiple topics). During subsequent analysis, the topic module 306 includes the topic proportions associated with each conversation in the machine learning models in order to determine which topics are most/least strongly predictive of outcomes.

In certain embodiments, the topic module 306 further determines a phase of the conversation based on the determined subject matter of the message. As used herein, the phase of the conversation indicates a predefined segment of the conversation such as introduction, request for help, conclusion, or the like. In one embodiment, the determined phase of the conversation may be used as input to the machine learning model to predict responses to the incoming message at the determined phase of the conversation to increase the likelihood that the outgoing message will result in the desired outcome.

In certain embodiments, the topic module 306 further performs topic modeling on the conversation based on the determined subject matters of the incoming and outgoing messages to determine a subject matter of the conversation e.g., battery malfunction, software crash, or the like. The determined subject matter of the conversation may be used to direct or steer the conversation towards the desired outcome. Accordingly, the topic module 306 may use the conversation topic as input to the machine learning model, in addition to other features described above, to predict responses to the incoming message that increase the likelihood that the outgoing message will result in the desired outcome. In some embodiments, the topic module 306 performs topic modeling using one or more of K-means clustering and Latent Dirichlet Allocation.

In one embodiment, the language module 308 is configured to analyze the incoming and outgoing messages to determine one or more textual predictors, which may be used to as inputs to the machine learning model to predict responses to the incoming message that increase the likelihood that the outgoing message will result in the desired outcome. The textual causes or predictors may include one or more of the following:
a. frequency of the use of specific keywords, n-grams, or phrases;
b. the proper use of punctuation, spelling, grammar, acronyms, and capitalization (wherein the use may be correct, incorrect, or deliberately novel);
c. the frequency of the use of words, symbols, abbreviations, or acronyms conveying emotion, polarity and magnitude of the sentiment in the message;
d. time delay between the outgoing and incoming messages; and
e. length and complexity of the incoming message.

Additional causes or predictors may be related to economic attributes of the entities, types of transactions or specific text used, such as lifetime-value-of-customer, average-order-size, conversion rate(s), retention and customer satisfaction. Any textual predictor, or combination of textual predictors, may be used, as would be recognized by one of skill in the art in light of this disclosure.

The following is a list of a set of possible textual predictors that may be used for the analysis. It is not an exclusive list and other predictors may be used, as is apparent to one of skill in the art. The list contains a non-exhaustive list of textual linguistic cues that the language module 308 may use:
a. Length of message
b. Length of conversation
c. Spelling and grammar
d. Use of capitalization
e. Use of punctuation
f Use of acronyms or abbreviations
g. Use of specific keywords, n-grams, or phrases
h. Sentiment analysis
i. Use of emoji and emoticons
j. Sexual language
k. Positive or negative language
l. Number of “selling” related words
m. Number of “helping” related words
n. Number of “sympathy” related words
o. Use of “small talk” words
p. Use of “empathy” words
q. Use of “rapport” words
r. Product and brand related terms
s. Words related to money or payment
t. Use of profanity words
u. Use of modern slang
v. Use of “complaint” words
w. Use of “encouragement” words
x. Use of “reassurance” words
y. Use of happy, amused, unamused, sad, angry, fear or worry words
z. Use of “persuasive” words
aa. Use of “charged” and “loaded” words
bb. Use of formal and informal language
cc. Use of first person pronouns
dd. Use of specific scripted language
ee. Use of time and location words
ff. Use of business process words
gg. Use of customer service words
hh. Use of health condition words
ii. Use of food words
jj Use of scripted phrases
kk. Use of habitual or favorite phrases

Any combination of the foregoing and other variables may be extracted from the messages and inserted into machine learning models. The machine learning models may then indicate responses that are optimal for the agent. This may be done as a one-size-fits-all approach (e.g., which responses produce engagement in a user), or done differently for each segment of user (e.g., a millennial vs. a businessman) or conversation topic (e.g., billing issues, shipping issues, product questions, or the like) The approach for segmenting visitors and grouping conversational topics may be inserted into the models and interacted with by the various agent-side linguistic cues in order to produce more customized recommendations that are visitor- or topic-specific.

Once the analysis module 204 performs an analysis, the results of the analysis are applied to the present, instant, or current conversation. In one embodiment, the analysis module 204 uses an application programming interface (“API”) that is connected to an analysis server 110 that is configured to: (1) receive messages from an external system, such as the user's client device 102 and/or an agent server 108; (2) analyzing the messages using machine learning models and algorithms as described above; and (3) transmitting messages back to the external system. The message module 202 may transmit incoming and outgoing messages to the analysis server 110 so that it is able to process, analyze, and understand the phase of the conversation, and assess the user's personality. When the message module 202 transmits an outgoing message to the analysis server 110 via the API, the analysis module 204 may perform message topic modeling, language extraction, and response prediction using machine learning models and algorithms.

The API may include a read/write API that allows protected access to cloud-based services (e.g., an analysis module 204 executing on the analysis server 110) capable of collecting, processing, and analyzing streams of chat key performance indicators (“KPI”), visitor/customer/user, and incoming/outgoing message data using machine learning models and algorithms. The analysis servers 110 may employ distributed processing across task-optimized compute instances with millisecond, microsecond, or the like end-to-end latency that allows services to perform rapid ingestion, topic modeling, language extraction, and predictive response generation using machine learning models and algorithms.

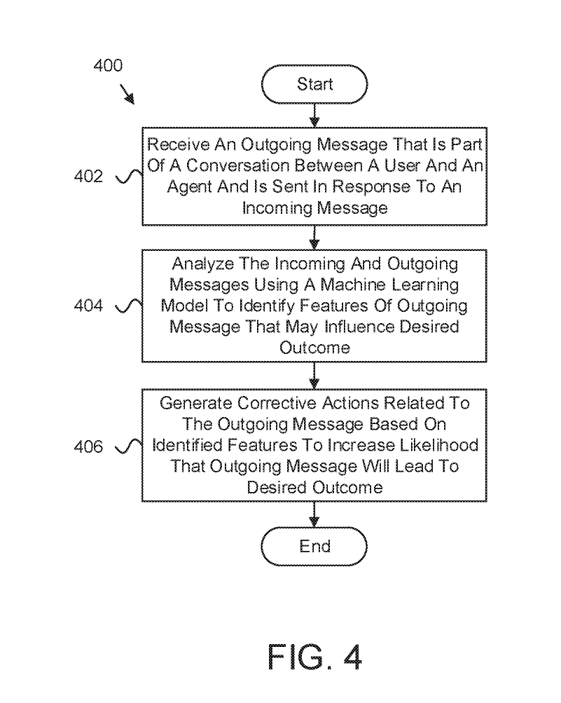

FIG. 4 depicts one embodiment of a method 400 for optimizing chat-based communications. In one embodiment, the method 400 begins and the message module 202 receives 402 an outgoing message intended for a user. The outgoing message may comprise a portion of a conversation between an agent and the user. The outgoing message may be generated in response to an incoming message from the user and received prior to sending the outgoing message to the user.

In some embodiments, the analysis module 204 analyzes 404 the incoming message and the outgoing message using a predefined machine learning model to identify one or more features of the outgoing message that have an influence on a desired outcome based on the incoming message. In certain embodiments, the action module 206 generates 406 one or more corrective actions related to the outgoing message based on the one or more features identified using the machine learning model. The one or more corrective actions may be intended to increase the likelihood that the outgoing message will result in the desired outcome, and the method 400 ends.

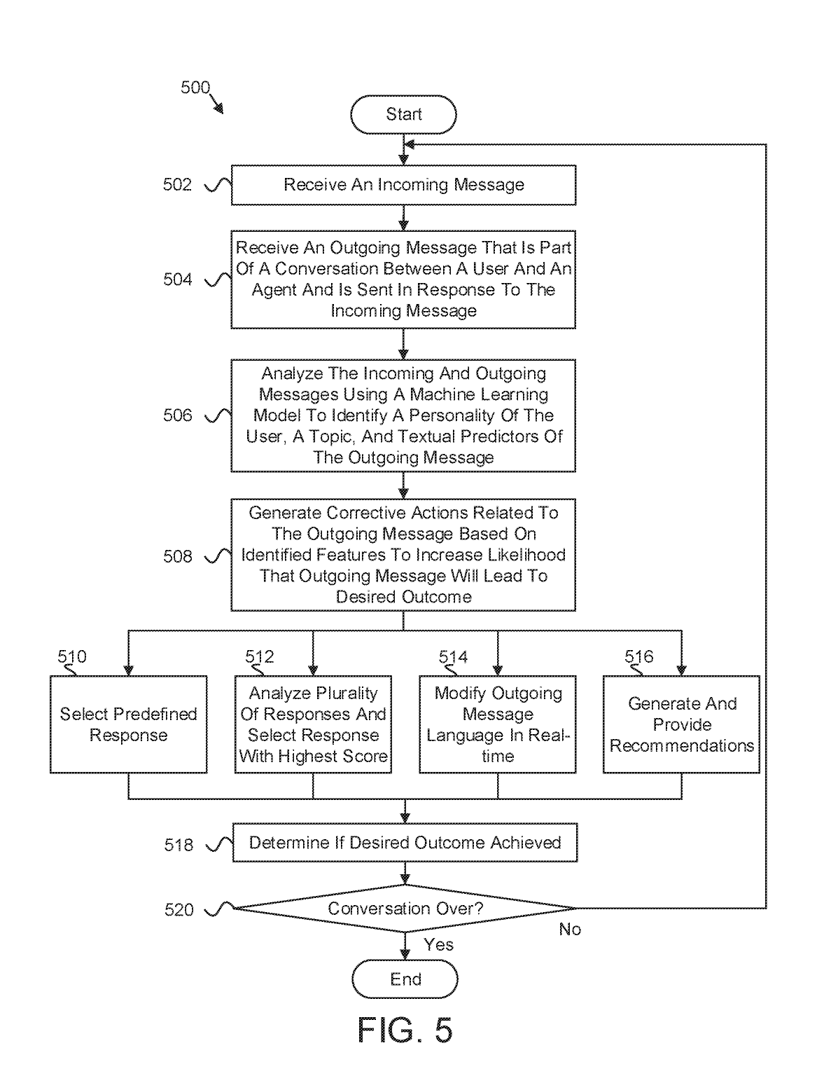

FIG. 5 depicts one embodiment of a method 500 for optimizing chat-based communications. In one embodiment, the method 500 begins and the message module 202 receives 502 an incoming message from a user, such as a customer. In response to the incoming message, the message module 202 receives 504 an outgoing message that is intended for the user. The outgoing message may comprise a portion of a conversation between an agent and the user. The outgoing message may be generated in response to an incoming message from the user and received prior to sending the outgoing message to the user.

In various embodiments, the analysis module 204 analyzes 506 the incoming message and the outgoing message using a predefined machine learning model to identify one or more features of the outgoing message that have an influence on a desired outcome based on the incoming message. In one embodiment, the action module 206 generates 508 one or more corrective actions related to the outgoing message based on the one or more features identified using the machine learning model. The one or more corrective actions may be intended to increase the likelihood that the outgoing message will result in the desired outcome.

For instance, the action module 206 may select 510 a response from a library of predefined responses. The selected response may have a higher likelihood of resulting in the desired outcome than the outgoing message. In certain embodiments, the action module 206 may analyze 512 a plurality of potential messages, including the outgoing message, using a decision tree and select the message that has the highest likelihood of resulting in the desired outcome.

In one embodiment, the action module 206 modifies 514 the language of the outgoing message in real-time in response to analyzing the outgoing message using the machine learning model with language variations within the message until a message that has the highest likelihood of resulting in the desired outcome is determined. In some embodiments, the action module 206 presents 516 one or more recommendations for increasing the likelihood of the outgoing message resulting in the desired outcome while the agent creates the outgoing message.

In one embodiment, the results module 302 determines 518 whether the desired outcome has been achieved for either a message and/or a conversation, and determines 520 whether the conversation is over. If not, the method 500 continues to receive 502 incoming messages from the user. Otherwise, the method 500 ends.

Means for receiving an outgoing message intended for a user includes, in various embodiments, one or more of a chat optimization apparatus 104, a message module 202, a device driver, a controller executing on a host computing device, a processor, an FPGA, an ASIC, other logic hardware, and/or other executable code stored on a computer-readable storage medium. Other embodiments may include similar or equivalent means for receiving an outgoing message intended for a user.

Means for receiving an outgoing message intended for a user includes, in various embodiments, one or more of a chat optimization apparatus 104, a message module 202, a device driver, a controller executing on a host computing device, a processor, an FPGA, an ASIC, other logic hardware, and/or other executable code stored on a computer-readable storage medium. Other embodiments may include similar or equivalent means for receiving an outgoing message intended for a user.

Means for analyzing incoming messages and outgoing messages using a predefined machine learning model includes, in various embodiments, one or more of a chat optimization apparatus 104, an analysis module 204, a device driver, a controller executing on a host computing device, a processor, an FPGA, an ASIC, other logic hardware, and/or other executable code stored on a computer-readable storage medium. Other embodiments may include similar or equivalent means for analyzing incoming messages and outgoing messages using a predefined machine learning model.

Means for generating one or more corrective actions related to the outgoing message includes, in various embodiments, one or more of a chat optimization apparatus 104, an action module 206, a device driver, a controller executing on a host computing device, a processor, an FPGA, an ASIC, other logic hardware, and/or other executable code stored on a computer-readable storage medium. Other embodiments may include similar or equivalent means for generating one or more corrective actions related to the outgoing message.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a message module that receives an outgoing message intended for a user, the outgoing message comprising a portion of a conversation between an agent and the user, the outgoing message generated in response to an incoming message from the user and received prior to sending the outgoing message to the user;
an analysis module that analyzes the incoming message and the outgoing message using a predefined machine learning model to identify one or more features of the outgoing message that have an influence on a desired outcome based on the incoming message, the machine learning model trained using a plurality of previous conversations; and
an action module that generates one or more corrective actions related to the outgoing message based on the one or more features identified using the machine learning model, the one or more corrective actions intended to increase the likelihood that the outgoing message will result in the desired outcome.

2. The apparatus of claim 1, further comprising a results module that determines whether the desired outcome has been achieved, the desired outcome comprising one of a message-level outcome and a conversation-level outcome.

3. The apparatus of claim 2, wherein the message-level outcome is intended to elicit a response from the user during the conversation, the results module analyzing, using the machine learning model, the user's response to the outgoing message during the conversation to determine whether the message-level outcome is achieved.

4. The apparatus of claim 2, wherein the conversation-level outcome is intended to persuade the user to perform an action at the end of the conversation, the results module analyzing one or more external data sources related to the conversation to determine whether the conversation-level outcome is achieved.

5. The apparatus of claim 1, wherein the one or more features of the outgoing message that have an influence on the desired outcome of the conversation are associated with one or more of a personality of the user, a topic, and textual predictors of the outgoing message.

6. The apparatus of claim 5, further comprising a personality module that analyzes, using the machine learning model, one or more conversational variables of the conversation to determine the personality of the user, the one or more conversational variables of the user comprising a timing in the user's responses, the user's use of pronouns, the user's spelling and grammar usage, the user's choice of words, the user's use of emoticons, and the user's writing style.

7. The apparatus of claim 6, wherein the personality module further segments the user based on the conversational variables and demographic variables associated with the user using one or more dimensionality reduction techniques, the segments used as input to the machine learning model to predict personalized responses to the incoming message that increase the likelihood that the outgoing message will result in the desired outcome.

8. The apparatus of claim 5, further comprising a topic module that performs topic modeling on at least one of the incoming and outgoing messages to determine a subject matter of the message, the topic modeling performed using one or more of K-means clustering and Latent Dirichlet Allocation.

9. The apparatus of claim 8, wherein the topic module further determines a phase of the conversation based on the determined subject matter of the message, the phase indicating a predefined segment of the conversation and used as inputs to the machine learning model to predict responses to the incoming message at the determined phase of the conversation that increase the likelihood that the outgoing message will result in the desired outcome.

10. The apparatus of claim 8, wherein the topic module further performs topic modeling on the conversation based on the determined subject matters of the incoming and outgoing messages to determine a subject matter of the conversation, the topic modeling performed using one or more of K-means clustering and Latent Dirichlet Allocation.

11. The apparatus of claim 5, further comprising a language module that analyzes the incoming and outgoing messages to determine the one or more textual predictors, the one or more textual predictors used as inputs to the machine learning model to predict responses to the incoming message that increase the likelihood that the outgoing message will result in the desired outcome.

12. The apparatus of claim 1, wherein the one or more corrective actions comprises selecting a response from a library of predefined responses, the selected response having a higher likelihood of resulting in the desired outcome than the outgoing message.

13. The apparatus of claim 1, wherein the one or more corrective actions comprises analyzing a plurality of potential messages, including the outgoing message, using a decision tree and selecting the message that has the highest likelihood of resulting in the desired outcome.

14. The apparatus of claim 1, wherein the one or more corrective actions comprises modifying the language of the outgoing message in real-time in response to analyzing the outgoing message using the machine learning model with language variations within the message until a message that has the highest likelihood of resulting in the desired outcome is determined.

15. The apparatus of claim 1, wherein the one or more corrective actions comprises presenting one or more recommendations for increasing the likelihood of the outgoing message resulting in the desired outcome in real-time while the agent creates the outgoing message.

16. An apparatus comprising:
means for receiving an outgoing message intended for a user, the outgoing message comprising a portion of a conversation between an agent and the user, the outgoing message generated in response to an incoming message from the user and received prior to sending the outgoing message to the user;
means for analyzing the incoming message and the outgoing message using a predefined machine learning model to identify one or more features of the outgoing message that have an influence on a desired outcome based on the incoming message, the machine learning model trained using a plurality of previous conversations; and
means for generating one or more corrective actions related to the outgoing message based on the one or more features identified using the machine learning model, the one or more corrective actions intended to increase the likelihood that the outgoing message will result in the desired outcome.

17. The apparatus of claim 16, wherein the one or more corrective actions comprises selecting a response from a library of predefined responses, the selected response having a higher likelihood of resulting in the desired outcome than the outgoing message.

18. The apparatus of claim 16, wherein the one or more corrective actions comprises analyzing a plurality of potential messages, including the outgoing message, using a decision tree and selecting the message that has the highest likelihood of resulting in the desired outcome.

19. The apparatus of claim 16, wherein the one or more corrective actions comprises modifying the language of the outgoing message in real-time in response to analyzing the outgoing message using the machine learning model with language variations within the message until a message that has the highest likelihood of resulting in the desired outcome is determined.

20. A method comprising:
receiving an outgoing message intended for a user, the outgoing message comprising a portion of a conversation between an agent and the user, the outgoing message generated in response to an incoming message from the user and received prior to sending the outgoing message to the user;
analyzing the incoming message and the outgoing message using a predefined machine learning model to identify one or more features of the outgoing message that have an influence on a desired outcome based on the incoming message, the machine learning model trained using a plurality of previous conversations; and
generating one or more corrective actions related to the outgoing message based on the one or more features identified using the machine learning model, the one or more corrective actions intended to increase the likelihood that the outgoing message will result in the desired outcome.
